(19) United States
(12) Patent Application Publication
(10) Pub. No.: US 2019/0248929 A1
(43) Pub. Date: Aug. 15, 2019

(54) Benzindenyl Catalyst Systems and Processes for Use Thereof

(71) Applicant: ExxonMobil Chemical Patents Inc., Baytown, TX (US)

(72) Inventor: Laughlin G. McCullough, League City, TX (US)

(21) Appl. No.: 16/270,027

(22) Filed: Feb. 7, 2019

Related U.S. Application Data
(60) Provisional application No. 62/629,196, filed on Feb. 12, 2018.

(51) Int. Cl. C08F 10/02

(52) U.S. Cl. CPC C08F 10/02

(57) ABSTRACT

This invention relates to a supported catalyst system and process for use thereof. In particular, the catalyst system includes a benzindenyl transition metal complex, a support material and an activator. The catalyst system may be used for preparing polyolefins, such as polyethylene.

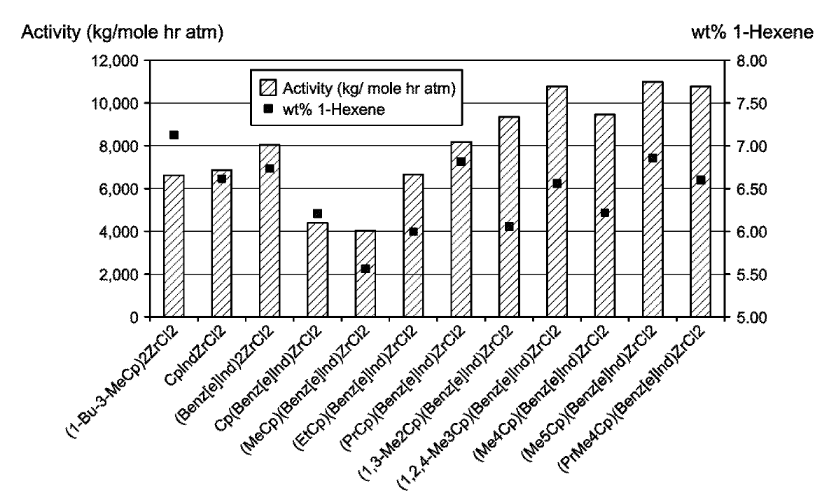

### PRIORITY CLAIM

This application claims priority to and the benefit of U.S. Ser. No. 62/629,196 filed Feb. 12, 2018 and is incorporated by reference in its entirety.

### CROSS-REFERENCE OF RELATED APPLICATIONS

This application relates to concurrently filed application U.S. Ser. No. 62/629,200, filed Feb. 12, 2018.

This application also relates to U.S. Ser. No. 15/706,088, filed Sep. 15, 2017.

FIELD OF INVENTION

This invention relates to a catalyst system and process for use thereof. In particular, the catalyst system comprises a benzindenyl transition metal compound, an activator, and a support material. The catalyst system may be used for olefin polymerization processes.

### BACKGROUND OF INVENTION

Olefin polymerization catalysts are of great use in industry. Hence, there is interest in finding new catalyst systems that increase the commercial usefulness of the catalyst and allow the production of polymers having improved properties. Catalysts for olefin polymerization are often based on cyclopentadienyl transition metal compounds as catalyst precursors combined with activators, typically an alumoxane or with an activator containing a non-coordinating anion.

There is still a need in the art for new and improved catalyst systems for the polymerization of olefins, in order to achieve increased activity or enhanced polymer properties, such as high melting point, higher density, high molecular weights, to increase conversion and/or comonomer incorporation, or to alter comonomer distribution without impacting the resulting polymer's properties. Specifically, there is still a need in the art for new and improved catalyst systems for the polymerization of olefins, in order to achieve increased activity and enhanced polymer properties, such as high molecular weights with good comonomer incorporation.

It is also an object of the present invention to provide novel supported catalysts systems and processes for the polymerization of olefins (such as ethylene) using such catalyst systems.

WO 2017/188602 discloses at paragraph [117] Me₂Si(Me₄Cp)(2-Me-benzindenyl)MCl₂.

US 2012/0245313 discloses a process to produce vinyl terminated polymers (having an Mn of 300 g/mol or more and at least 30% allyl chain ends) comprising contacting one or more olefins with a transition metal catalyst compound, which may be selected from: (CpMe₅) (1,3-Me₂benz[e]indenyl)HfMe₂, (CpMe₅)(1-methyl-3-n-propylbenz[e]indenyl)HfMe₂, (CpMe₅)(1-n-propyl,3-methylbenz[e]indenyl)HfMe₂, (CpMe₅)(1-methyl-3-n-butylbenz[e]indenyl)HfMe₂, (CpMe₅)(1-n-butyl,3-methylbenz[e]indenyl)HfMe₂, (CpMe₅)(1-ethyl,3-methylbenz[e]indenyl)HfMe₂, (CpMe₅)(1 -methyl, 3-ethylbenz[e]indenyl)HfMe₂, (CpMe₄n-propyl)(1 ,3-Me₂benz[e]indenyl)HfMe₂, (CpMe₄-n-propyl)(1-methyl-3-n-propylbenz[e]indenyl)HfMe₂, (CpMe₄-n-propyl)(1-n-propyl,3-methylbenz[e]indenyl)HfMe₂, (CpMe₄-n-propyl)(1-methyl-3-n-butylbenz[e]indenyl)HfMe₂, (CpMe₄-n-propyl)(1-n-butyl,3-methylbenz[e]indenyl)HfMe₂, (CpMe₄-n-propyl)(1-ethyl,3-methylbenz[e]indenyl)HfMe₂, (CpMe₄-n-propyl)(1-methyl, 3-ethylbenz[e]indenyl)HfMe₂, (CpMe₄n-butyl)(1,3-Me₂benz[e]indenyl)HfMe₂, (CpMe₄n-butyl)(1-methyl-3-n-propylbenz[e]indenyl)HfMe₂, (CpMe4n-butyl)(1-n-propyl,3-methylbenz[e]indenyl)HfMe₂, (CpMe₄n-butyl)(1-methyl-3-n-butylbenz[e]indenyl)HfMe₂, (CpMe₄n-butyl)(1-n-butyl,3-methylbenz [e]indenyl)HfMe₂, (CpMe₄n-butyl)(1-ethyl,3-methylbenz[e]indenyl)HfMe₂, (CpMe₄n-butyl)(1-methyl, 3-ethylbenz[e]indenyl)HfMe₂, and the zirconium analogs thereof, or where Mee after the transition metal is replaced with a dihalide or a bisphenoxide.

Other references of interest include: U.S. Patent Publication Nos. 2004/0102590; 2010/017829; 2010/0038290; 2017/233516; U.S. Pat. Nos. 6,818,585; 7,199,072; 6,403,732; 7,214,745; 8,816,027; 8,669,326; 8,940,839; 8,754,170; 8,426,659; 8,841,397; 8,501,894; 8,669,330; 8,835,563; 8,841,394; 8,399,724; 8,623,974; 8,981,029; U.S. Ser. No. 15/921,757 filed Mar. 15, 2018; 15/921,933 filed Mar. 15, 2018; PCT Publication Nos. WO 95/27717; WO 2009/155471; WO 2009/155472; WO 2009/155510; WO 2009/155517; WO 2017/155149; WO 2012/133717; WO 2012/134720; Japanese Publication No. JP 2005-336092; Chinese Publication No. CN 105622807; EP Publication Nos. EP 0659756; EP 0610851; Korean Publication No. KR 17250040000; Teuben et al. (J. Mol. Catal., 62, 1990, pp. 277-87); X. Yang et al. (Angew. Chem., Int'l Edn., Engl., 31, 1992, pp. 1375-1377); Small and Brookhart (Macromol., 32, 1999, pp. 2120-2130); Weng et al. (Macromol Rapid Comm., 2000, 21, pp. 1103-1107); Macromolecules, 33, 2000, pp. 8541-8548; Moscardi et al. (Organomet., 20, 2001, pp. 1918); Zhu et al. (Macromol., 2002, 35, pp. 10062-10070 and Macromol. Rap. Commun., 2003, 24, pp. 311-315); Coates et al. (Macromol., 2005, 38, pp. 6259-6268); Rose et al. (Macromolecules, 2008, 41, pp. 559-567); and Janiak and Blank (Macromol. Symp., 236, 2006, pp. 14-22).

### SUMMARY OF INVENTION

This invention relates to a supported catalyst system comprising: (i) at least one first catalyst component comprising a benzindenyl transition metal complex; (iii) activator; and (iv) a support; wherein the benzindenyl transition metal complex is represented by the formula (A):

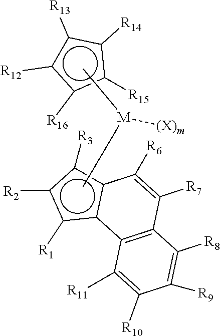

wherein:

R¹ and R³ are hydrogen;

each R₂, R₆, R₇, R₈, R₉, R₁₀, R₁₁, R¹², R₁₃, R₁₄, and R¹⁶ are each, independently, a hydrogen, or a substituted or unsubstituted linear, branched, or cyclic C₁ to C₂₀ hydrocarbyl group, optionally two or more R moieties (typically adjacent R moieties) may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.

This invention also relates to a process for polymerization of monomers (such as olefin monomers) comprising contacting one or more monomers with the above supported catalyst systems.

This invention also relates to a process to produce ethylene polymer compositions comprising: i) contacting in a single reaction zone, in the gas phase or slurry phase, ethylene and C₃ to C₂₀ comonomer with a catalyst system comprising a support, an activator, and benzindenyl transition metal complex represented by formula (A) above, and ii) preferably obtaining an in-situ ethylene polymer composition having at least 50 mol % ethylene and a density of 0.91 g/cc or more, alternately 0.935 g/cc or more.

### BRIEF DESCRIPTION OF THE DRAWINGS

The Figure is a graph of activity and hexane incorporation for catalyst compounds in the Experimental section.

### DETAILED DESCRIPTION OF THE PRESENT INVENTION

For purposes of this invention and the claims thereto, a “catalyst system” is a combination of at least one catalyst compound, an activator, and a support material. The catalyst systems may further comprise one or more additional catalyst compounds. The term “supported catalyst system” may be used interchangeably herein with “catalyst system.” For the purposes of this invention and the claims thereto, when catalyst systems are described as comprising neutral stable forms of the components, it is well understood by one of ordinary skill in the art, that the ionic form of the component is the form that reacts with the monomers to produce polymers.

The term “complex” is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal. “Complex,” as used herein, is also often referred to as “catalyst precursor,” “pre-catalyst,” “catalyst,” “catalyst compound,” “metal compound,” “transition metal compound,” or “transition metal complex.” These words are used interchangeably. “Activator” and “cocatalyst” are also used interchangeably.

The terms “hydrocarbyl radical,” “hydrocarbyl,” and “hydrocarbyl group” are used interchangeably throughout this document. Likewise the terms “group,” “radical,” and “substituent” are also used interchangeably in this document. For purposes of this invention, “hydrocarbyl radical” is defined to be C₁-C₁₀₀ radicals, that may be linear, branched, or cyclic, and when cyclic, aromatic or non-aromatic.

For purposes of this invention and claims thereto, unless otherwise indicated, the term “substituted” means that a hydrogen group has been replaced with a heteroatom, or a heteroatom containing group. For example, substituted hydrocarbyl radicals are radicals in which at least one hydrogen atom of the hydrocarbyl radical has been substituted with at least one functional group such as Cl, Br, F, I, NR*_{2,} OR*, SeR*, TeR*, PR*_{2,} AsR*₂, SbR*₂, SR*, BR*₂, SiR*₃, GeR*₃, SnR*₃, PbR*₃ and the like (where R* is H or a C₁ to C₂₀ hydrocarbyl group), or where at least one heteroatom has been inserted within a hydrocarbyl ring.

The term “ring atom” means an atom that is part of a cyclic ring structure. By this definition, a benzyl group has six ring atoms and tetrahydrofuran has 5 ring atoms.

A “ring carbon atom” is a carbon atom that is part of a cyclic ring structure. By this definition, a benzyl group has six ring carbon atoms and para-methylstyrene also has six ring carbon atoms.

The term “aryl” or “aryl group” means a six carbon aromatic ring and the substituted variants thereof, including but not limited to, phenyl, 2-methyl-phenyl, xylyl, 4-bromo-xylyl. Likewise, heteroaryl means an aryl group where a ring carbon atom (or two or three ring carbon atoms) has been replaced with a heteroatom, preferably, N, O, or S.

A “heterocyclic ring” is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

As used herein the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The term “continuous” means a system that operates without interruption or cessation. For example, a continuous process to produce a polymer would be one where the reactants are continually introduced into one or more reactors and polymer product is continually withdrawn.

As used herein, the numbering scheme for the Periodic Table groups is the new notation as set out in Chemical and Engineering News, 63(5), 27, (1985).

An “olefin,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. “Different” as used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

For purposes of this invention and the claims thereto, an ethylene polymer having a density of 0.86 g/cm³ or less is referred to as an ethylene elastomer or elastomer; an ethylene polymer having a density of more than 0.86 to less than 0.910 g/cm³ is referred to as an ethylene plastomer or plastomer; an ethylene polymer having a density of 0.910 to 0.940 g/cm³ is referred to as a low density polyethylene; and an ethylene polymer having a density of more than 0.940 g/cm³ is referred to as a high density polyethylene (HDPE). Density is determined according to ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³).

Polyethylene in an overlapping density range, i.e., 0.890 to 0.930 g/cm³, typically from 0.915 to 0.930 g/cm³, which is linear and does not contain long chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or in solution reactors. “Linear” means that the polyethylene has no long chain branches, typically referred to as a branching index (g′ᵥᵢₛ) of 0.97 or above, preferably 0.98 or above. Branching index, g′ᵥ, is measured as described below.

For the purposes of this invention, ethylene shall be considered an α-olefin.

As used herein, Mᵣ, is number average molecular weight, M_{w} is weight average molecular weight, and M_{z} is z average molecular weight, wt % is weight percent, and mol % is mole percent. Molecular weight distribution (MWD), also referred to as polydispersity index (PDI), is defined to be Mw divided by Mn. Unless otherwise noted, all molecular weights (e.g., Mw, Mn, Mz) are reported in units of g/mol. The following abbreviations may be used herein: Me is methyl, Et is ethyl, t-Bu and ^{t}Bu are tertiary butyl, iPr and ⁱPr are isopropyl, Cy is cyclohexyl, THF (also referred to as the is tetrahydrofuran, Bn is benzyl, Ph is phenyl, Cp is cyclopentadienyl, Cp* is pentamethyl cyclopentadienyl, Ind is indenyl, Flu is fluorenyl, and MAO is methylalumoxane.

### DESCRIPTION

This invention relates to a process to produce olefin (preferably ethylene) polymer compositions comprising: i) contacting in a single reaction zone, in the gas phase or slurry phase, ethylene and C₃ to C₂₀ comonomer (preferably propylene, 1-butene, 1-hexene, 1-octene or a mixture thereof) with a catalyst system comprising a support, an activator, and benzindenyl transition metal complex, and ii) preferably obtaining an ethylene polymer composition having at least 50 mol % ethylene, a density of 0.91 g/cc or more, alternately 0.935 g/cc or more, and optionally a melt index (ASTM 1238, 2.16 kg, 190° C.) of 20 dg/min or less, wherein the benzindenyl transition metal complex is represented by the formula (A):

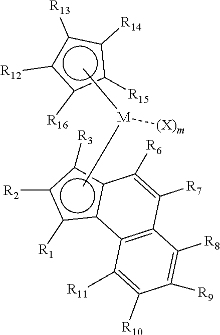

wherein:

R¹and R³ are hydrogen;

each R², R⁶, R⁷, R⁸, R⁹, R¹⁰, RH¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, preferably C₁-C₈, hydrocarbyl group, optionally two or more R moieties (typically adjacent R moieties) may together form a fused ring or ring system;

M is a group 4 transition metal (preferably Hf, Ti, or Zr);

each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system; and

m is 1, 2 or 3 (preferably 2), preferably M is Zr or Hf and m is 2.

This invention also relates to a supported catalyst system comprising: (i) at least one catalyst component comprising a benzindenyl transition metal complex; (ii) an activator, and (iii) a support material; wherein the benzindenyl transition metal complex is represented by the formula (A):

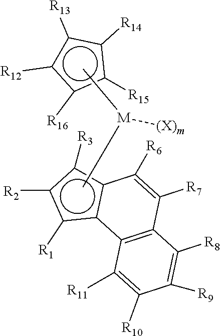

wherein:

R¹ and R³ are hydrogen;

each R², R₆, R₇, R⁸, R₉, R¹⁰, R¹¹, R¹², R¹³, R¹⁴, R¹⁵ and R¹⁶ are each, independently, a hydrogen, or a substituted or unsubstituted linear, branched, or cyclic C₁ to C₂₀ hydrocarbyl group, preferably C₁-C₈, hydrocarbyl group, optionally two or more R moieties (typically adjacent R moieties) may together form a fused ring or ring system;

M is a group 4 transition metal (preferably Hf, Ti, or Zr);

each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system; and

m is 1, 2 or 3 (preferably 2), preferably M is Zr or Hf and m is 2.

Benzindenyl Transition Metal Complex

For purposes of this invention and claims thereto in relation to benzindenyl transition metal complexes, the term “substituted” means that a hydrogen group has been replaced with a hydrocarbyl group, a heteroatom, or a heteroatom containing group. For example, methyl cyclopentadiene (Cp) is a Cp group substituted with a methyl group.

For purposes of this invention and claims thereto, “alkoxides” include those where the alkyl group is a C₁ to C₁₀ hydrocarbyl. The alkyl group may be straight chain, branched, or cyclic. The alkyl group may be saturated or unsaturated. In some embodiments, the alkyl group may comprise at least one aromatic group.

This invention relates to benzindenyl transition metal complexes represented by formula:

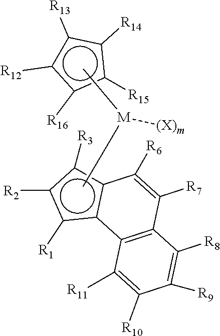

wherein:

R¹ and R³ are hydrogen;

each R², R⁶, R⁷, R⁸, R⁹, R¹⁰, R¹¹, R¹², R¹³, R¹⁴, R¹⁵ and R¹⁶ are each, independently, a hydrogen, or a substituted or unsubstituted linear, branched, or cyclic C₁ to C₂₀ hydrocarbyl group, preferably C hydrocarbyl group, optionally two or more R moieties (typically adjacent R moieties) may together form a fused ring or ring system;

M is a group 4 transition metal (preferably Hf, Ti, or Zr);

each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system; and

m is 1, 2 or 3(preferably 2), preferably M is Zr or Hf and m is 2.

In some embodiments, preferred examples of C₁-C₂₀ substituted or unsubstituted linear, branched, or cyclic hydrocarbyl groups can include, but are not necessarily limited to:

methyl, ethyl, n-propyl, isopropyl, n-butyl, 1-methylpropyl, 1-ethylethyl, n-pentyl, 1-methylpentyl, 1-ethylpropyl, 1-hexyl, 1-methylpentyl, 1-ethylbutyl, 1-propylpropyl, optionally substituted cyclohexyl, optionally substituted phenyl, optionally substituted benzyl, and the like, and any ethylenically unsaturated group that can be derived from them by eliminating one available hydrogen group from each of two adjacent carbon atoms therein.

In some embodiments, each X is independently a halogen or a substituted or unsubstituted linear, branched linear, or cyclic C hydrocarbyl group, e.g., a methyl, an ethyl, a propyl, a butyl, a phenyl, a benzyl, a chloride, a bromide, or an iodide.

Preferably, each R₂, R₆, R₇, R₈, R₉, R₁₀, R₁₁, R₁₂, R₁₃, R₁₄, R⁵, and R¹⁶ is, independently, hydrogen or a substituted or unsubstituted linear, branched linear, or cyclic C₁-C₆ hydrocarbyl group (e.g., a methyl, an ethyl, a propyl, a butyl, a cyclohexyl, or a phenyl).

Preferably at least 1 (alternately at least 2, alternately at least 3, alternately at least 4, alternately 5) of R₁₂, R₁₃, R₁₄, R¹⁵, and R¹⁶ is a substituted a substituted linear, branched, or cyclic C₁ to C₂₀ hydrocarbyl group, preferably C₁-C₈ hydrocarbyl group, where optionally two or more R moieties (typically adjacent R moieties) may together form a fused ring or ring system.

Preferably at least 1 (alternately at least 2, alternately at least 3, alternately at least 4, alternately 5) of R¹², R¹³, R¹⁴, R¹⁵, and R¹⁶ is a substituted linear, branched linear, or cyclic C₁-C₆ hydrocarbyl group (e.g., a methyl, an ethyl, a propyl, a butyl, a cyclohexyl, or a phenyl).

Particularly useful benzindenyl transition metal complexes useful herein include: (Benz[e]Ind)₂MX_{2,} Cp(Benz[e]Ind)MX₂, (MeCp)(Benz[e]Ind)MX₂, (EtCp)(Benz[e]Ind)MX₂, (PrCp)(Benz[e]Ind)MX₂, (1 ,3 -Me2Cp)(Benz[e]Ind)MX₂, (1,2,4-Me₃Cp)(Benz[e]Ind)MX₂, (Me₄Cp)(Benz[e]Ind)MX₂, (MesCp)(Benz[e]Ind)MX₂, (PrMe₄Cp)(Benz[e]Ind)MX₂, where M is Hf or Zr, and X is I, Cl, Br, Me, Et, Pr, Bu, or phenoxide; preferably, (Benz[e]Ind)₂ZrCl₂, Cp(Benz[e]Ind)ZrCl₂, (MeCp)(Benz[e]Ind)ZrCl₂, (EtCp)(Benz[e]Ind)ZrCl₂, (PrCp)(Benz[e]Ind)ZrCl₂, (1,3-Me₂Cp)(Benz[e]Ind)ZrCl₂, (1,2,4-Me₃Cp)(Benz[e]Ind)ZrCl₂, (Me₄Cp)(Benz[e]Ind)ZrCl₂, (Me₅Cp)(Benz[e]Ind)ZrCl₂, and (PrMe₄Cp)(Benz[e]Ind)ZrCl_{2.}

Benzindenyl transition metal complexes generally can be synthesized by using typical chemical reagents (e.g., halides of hafnium, zirconium, titanium) and intermediates (such as ligands containing one a substituted or unsubstituted Cp ring, benzindenyl rings, and the like) that are commercially available, and following typical reaction schemes exemplified in various synthesis descriptions, e.g., as described in the example sections of U.S. Provisional Application Nos. 62/477,683 and 62/477,706, both filed Mar. 28, 2017, the contents of each of which are hereby incorporated by reference.

It is contemplated that the catalyst components described above include their structural or optical or enantiomeric isomers (racemic mixture), and may be a pure enantiomer in one embodiment.

In a preferred embodiment in any of the processes described herein one catalyst compound is used, e.g. the catalyst compounds used in the polymerization process(es) are not different. For purposes of this invention one catalyst compound is considered different from another if they differ by at least one atom. For example “bisindenyl zirconium dichloride” is different from “(indenyl)(2-methylindenyl) zirconium dichloride” which is different from “(indenyl)(2-methylindenyl) hafnium dichloride.” Catalyst compounds that differ only by isomer are considered the same for purposes of this invention, e.g., rac-dimethylsilylbis(2-methyl 4-phenyl)hafnium dimethyl is considered to be the same as meso-dimethylsilylbis(2-methyl 4-phenyl)hafnium dimethyl.

In some embodiments, two or more different catalyst compounds are present in the catalyst system used herein. In some embodiments, two or more different catalyst compounds are present in the reaction zone where the process(es) described herein occur. When two transition metal compound based catalysts are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal compounds are compatible. It is preferable to use the same activator for the transition metal compounds, however, two different activators, such as a non-coordinating anion activator and an alumoxane, can be used in combination. If one or more transition metal compounds contain an X¹ or X² ligand which is not a hydride, hydrocarbyl, or substituted hydrocarbyl, then the alumoxane should be contacted with the transition metal compounds prior to addition of the non-coordinating anion activator.

The two transition metal compounds (pre-catalysts) may be used in any ratio.

Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Support Material

In embodiments of the invention herein, the catalyst systems comprise a support material. Preferably, the support material is a porous support material, for example, talc, and inorganic oxides. Other support materials include zeolites, clays, organoclays, or any other organic or inorganic support material, or mixtures thereof. As used herein, “support” and “support material” are used interchangeably.

Preferably, the support material is an inorganic oxide in a finely divided form. Suitable inorganic oxide materials for use in the supported catalyst systems herein include Groups 2, 4, 13, and 14 metal oxides such as silica, alumina, and mixtures thereof. Other inorganic oxides that may be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably, SiO₂, Al₂O₃, or SiO₂/Al₂O₃.

It is preferred that the support material, most preferably, an inorganic oxide, has a surface area in the range of from about 10 m²/g to about 700 m²/g, pore volume in the range of from about 0.1 cc/g to about 4.0 cc/g, and average particle size in the range of from about 5 μm to about 500 μm. More preferably, the surface area of the support material is in the range of from about 50 m²/g to about 500 m²/g, pore volume of from about 0.5 cc/g to about 3.5 cc/g, and average particle size of from about 10 μm to about 200 μm. Most preferably, the surface area of the support material is in the range of from about 100 m²/g to about 400 m²/g, pore volume from about 0.8 cc/g to about 3.0 cc/g, and average particle size is from about 5 μm to about 100 μm. The average pore size of the support material useful in the invention is in the range of from 10 to 1,000 Å, preferably, 50 to about 500 Å, and most preferably, 75 to about 350 Å. In some embodiments, the support material is a high surface area, amorphous silica (surface area ≥300 m²/gm, pore volume ≥1.65 cm³/gm), and is marketed under the tradenames of DAVISON 952 or DAVISON 955 by the Davison Chemical Division of W. R. Grace and Company, are particularly useful. In other embodiments, DAVIDSON 948 is used.

In some embodiments of this invention, the support material may be dry, that is, free of absorbed water. Drying of the support material can be achieved by heating or calcining at about 100° C. to about 1000° C., preferably, at least about 600° C. When the support material is silica, it is typically heated to at least 200° C., preferably, about 200° C. to about 850° C., and most preferably, at about 600° C.; and for a time of about 1 minute to about 100 hours, from about 12 hours to about 72 hours, or from about 24 hours to about 60 hours. The calcined support material, preferably, has at least some reactive hydroxyl (OH) groups.

In a particularly useful embodiment, the support material is fluorided. Fluoriding agent containing compounds may be any compound containing a fluorine atom. Particularly desirable are inorganic fluorine containing compounds are selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, NF₃, HF, BF₃, NHF₂ and NH₄HF₂. Of these, ammonium hexafluorosilicate and ammonium tetrafluoroborate are useful. Combinations of these compounds may also be used.

Ammonium hexafluorosilicate and ammonium tetrafluoroborate fluorine compounds are typically solid particulates as are the silicon dioxide supports. A desirable method of treating the support with the fluorine compound is to dry mix the two components by simply blending at a concentration of from 0.01 to 10 0 millimole F/g of support, desirably in the range of from 0.05 to 6.0 millimole F/g of support, and most desirably in the range of from 0.1 to 3.0 millimole F/g of support. The fluorine compound can be dry mixed with the support either before or after charging to a vessel for dehydration or calcining the support. Accordingly, the fluorine concentration present on the support is in the range of from 0.1 to 25 wt %, alternately 0.19 to 19 wt %, alternately from 0.6 to 3.5 wt %, based upon the weight of the support.

The above two metal catalyst components described herein are generally deposited on the support material at a loading level of 10-100 micromoles of metal per gram of solid support; alternately 20-80 micromoles of metal per gram of solid support; or 40-60 micromoles of metal per gram of support. But greater or lesser values may be used provided that the total amount of solid complex does not exceed the support's pore volume.

### Activators

The catalyst systems described herein typically comprises a catalyst complex as described above and an activator such as alumoxane or a non-coordinating anion and may be formed by combining the catalyst components described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, 6-bound, metal ligand making the metal compound cationic and providing a charge-balancing noncoordinating or weakly coordinating anion, e.g. a non-coordinating anion.

Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA. It is within the scope of this invention to use an ionizing activator, neutral or ionic. It is also within the scope of this invention to use neutral or ionic activators alone or in combination with alumoxane or modified alumoxane activators. For descriptions of useful activators please see U.S. Pat. Nos. 8,658,556 and 6,211,105.

Preferred activators include N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis (3,5-bis(trifluoromethyl)phenyl)borate, triphenylcarbenium tetrakis(perfluorophenyl)borate, [Me₃NH+][B(C₆F₅)₄⁻]; 1 -(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbonium (such as triphenylcarbenium tetraphenylborate, triphenylcarbenium tetrakis(pentafluorophenyl)borate, triphenylcarbenium tetrakis -(2,3,4,6-tetrafluorophenyl)borate, triphenylcarbenium tetrakis(perfluoronaphthyl)borate, triphenylcarbenium tetrakis (perfluorobiphenyeborate, triphenylcarbenium tetrakis (3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis (3,5-bis(trifluoromethyl)phenyl)borate, N,N-dialkylanilinium tetrakis (3,5-bis(trifluoromethyl)phenyl)borate, N,N-dialkyl-(2,4,6-trimethylanilinium) tetrakis (3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

In an embodiment the, activator is represented by the formula:

(Z)_{d}⁺(A^{d-})

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3, preferably Z is (Ar₃C+), where Ar is aryl or aryl substituted with a heteroatom, a C₁ to C₄₀ hydrocarbyl, or a substituted C₁ to C₄₀ hydrocarbyl.

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA's (see for example, U.S. Pat. No. 5,153,157; U.S. Pat. No. 5,453,410; EP 0 573 120 B1; WO 94/07928; and WO 95/14044 (the disclosures of which are incorporated herein by reference in their entirety) which discuss the use of an alumoxane in combination with an ionizing activator).

### Optional Scavengers or Co-Activators

In addition to the activator compounds, scavengers, chain transfer agents or co-activators may be used. Aluminum alkyl or organoaluminum compounds which may be utilized as co-activators include, for example, trimethylaluminum, triethylaluminum, triisobutylaluminum, tri-n-hexylaluminum, tri-n-octylaluminum, and diethyl zinc.

In some embodiments, the catalyst systems will additionally comprise one or more scavenging compounds. Here, the term “scavenger” means a compound that removes polar impurities from the reaction environment. These impurities adversely affect catalyst activity and stability. Typically, the scavenging compound will be an organometallic compound such as the Group-13 organometallic compounds of U.S. Pat. No. 5,153,157; U.S. Pat. No. 5,241,025; and WO 91/09882; WO 94/03506; WO 93/14132; and that of WO 95/07941. Exemplary compounds include triethyl aluminum, triethyl borane, tri-iso-butyl aluminum, methyl alumoxane, iso-butyl alumoxane, and tri-n-octyl aluminum. Those scavenging compounds having bulky or C₆-C₂₀ linear hydrocarbyl substituents connected to the metal or metalloid center usually minimize adverse interaction with the active catalyst. Examples include triethyl aluminum, but more preferably, bulky compounds such as tri-iso-butyl aluminum, tri-iso-prenyl aluminum, and long-chain linear alkyl-substituted aluminum compounds, such as tri-n-hexyl aluminum, tri-n-octyl aluminum, or tri-n-dodecyl aluminum. When alumoxane is used as the activator, any excess over that needed for activation will scavenge impurities and additional scavenging compounds may be unnecessary. Alumoxanes also may be added in scavenging quantities with other activators, e.g., methylalumoxane, [Me₂HNPh]+[B(pfp)₄]⁻or B(pfp)₃ (perfluorophenyl=pfp=C₆F₅).

Preferred aluminum scavengers useful in the invention include those where there is oxygen present. That is, the material per se or the aluminum mixture used as a scavenger, includes an aluminum/oxygen species, such as an alumoxane or alkylaluminum oxides, e.g., dialkyaluminum oxides, such as bis(diisobutylaluminum) oxide. In one aspect, aluminum containing scavengers can be represented by the formula ((R_{z}—Al—)_{y}O—)ₓ, wherein z is 1-2, y is 1-2, x is 1-100, and R is a C₁-C₁₂ hydrocarbyl group. In another aspect, the scavenger has an oxygen to aluminum (O/Al) molar ratio of from about 0.25 to about 1.5, more particularly from about 0.5 to about 1.

### Preparation of Catalyst Systems

The above components can be combined to form a catalyst system.

If two or more metal compounds are used, the two or more metal compounds can be added together in a desired ratio when combined, contacted with an activator, or contacted with a support material or a supported activator. The metal compounds may be added to the mixture sequentially or at the same time.

The metal compound may be supported via contact with a support material for a reaction time. The resulting supported catalyst composition may then be mixed with mineral oil to form a slurry, which may or may not include an activator. The slurry may then be introduced into a polymerization reactor.

The catalyst system may be formed by combining a metal compound with a support and activator, desirably in a diluent such as an alkane or toluene, to produce a supported, activated catalyst compound. The supported activated catalyst compound, either isolated from the first diluent or not, is then combined in one embodiment with a high viscosity diluent such as mineral or silicon oil, or an alkane diluent comprising from 5 to 99 wt % mineral or silicon oil to form a slurry of the supported metal compound, followed by, or simultaneous to combining with an optional second metal compound, either in a diluent or as the dry solid compound, to form a supported activated catalyst system. The catalyst system thus produced may be a supported and activated metal compound in a slurry, the slurry comprising mineral or silicon oil, with an optional second metal compound that is not supported and not combined with additional activator, where the second metal compound may or may not be partially or completely soluble in the slurry. In one embodiment, the diluent consists of mineral oil.

Mineral oil, or “high viscosity diluents,” as used herein refers to petroleum hydrocarbons and mixtures of hydrocarbons that may include aliphatic, aromatic, and/or paraffinic components that are liquids at 23° C. and above, and typically have a molecular weight of at least 300 amu to 500 amu or more, and a viscosity at 40° C. of from 40 to 300 cSt or greater, or from 50 to 200 cSt in a particular embodiment. The term “mineral oil” includes synthetic oils or liquid polymers, polybutenes, refined naphthenic hydrocarbons, and refined paraffins known in the art, such as disclosed in BLUE BOOK 2001, MATERIALS, COMPOUNDING INGREDIENTS, MACHINERY AND SERVICES FOR RUBBER 189 247 (J. H. Lippincott, D. R. Smith, K. Kish & B. Gordon eds. Lippincott & Peto Inc. 2001).

Preferred mineral and silicon oils useful in the present invention are those that exclude moieties that are reactive with metallocene catalysts, examples of which include hydroxyl and carboxyl groups.

The diluent may comprise a blend of a mineral, silicon oil, and/or and a hydrocarbon selected from the group consisting of C₁ to C₁₀ alkanes, C₆ to C₂₀ aromatic hydrocarbons, C₇ to C₂₁ alkyl-substituted hydrocarbons, and mixtures thereof. When the diluent is a blend comprising mineral oil, the diluent may comprise from 5 to 99 wt % mineral oil. In some embodiments, the diluent may consist essentially of mineral oil.

A wide range of mixing temperatures may be used at various stages of making the catalyst system. For example, in a specific embodiment, when the metal compound and at least one activator, such as methylalumoxane, are combined with a diluent to form a mixture, which is preferably, heated to a first temperature of from 25° C. to 150° C., preferably, from 50° C. to 125° C., more preferably, from 75° C. to 100° C., most preferably, from 80° C. to 100° C. and stirred for a period of time from 30 seconds to 12 hours, preferably, from 1 minute to 6 hours, more preferably, from 10 minutes to 4 hours, and most preferably, from 30 minutes to 3 hours.

Next, that mixture is combined with a support material to provide a support slurry. The support material can be heated, or dehydrated if desired, prior to combining. In one or more embodiments, the support slurry is mixed at a temperature greater than 50° C., preferably, greater than 70° C., more preferably, greater than 80° C. and most preferably, greater than 85° C., for a period of time from 30 seconds to 12 hours, preferably, from 1 minute to 6 hours, more preferably, from 10 minutes to 4 hours, and most preferably, from 30 minutes to 3 hours. Preferably, the support slurry is mixed for a time sufficient to provide a collection of activated support particles that have the first metal compound deposited thereto. The diluent can then be removed from the first support slurry to provide a dried supported first catalyst compound. For example, the diluent can be removed under vacuum or by nitrogen purge.

The diluent is an aromatic or alkane, preferably, hydrocarbon diluent having a boiling point of less than 200° C. such as toluene, xylene, hexane, etc., may be removed from the supported first metal compound under vacuum or by nitrogen purge to provide a supported mixed catalyst system. Even after addition of the oil and/or the optional second catalyst compound, it may be desirable to treat the slurry to further remove any remaining solvents such as toluene. This can be accomplished by an Na purge or vacuum, for example. Depending upon the level of mineral oil added, the resultant mixed catalyst system may still be a slurry or may be a free flowing powder that comprises an amount of mineral oil. Thus, the catalyst system, while a slurry of solids in mineral oil in one embodiment, may take any physical form such as a free flowing solid. For example, the catalyst system may range from 1 to 99 wt % solids content by weight of the mixed catalyst system (mineral oil, support, all catalyst compounds and activator(s)) in one embodiment. Polymerization Process

In embodiments herein, the invention relates to polymerization processes where monomer (such as ethylene), and, optionally, comonomer (such as hexene), are contacted with a supported catalyst system comprising a benzindenyl transition metal complex, an activator and a support material as described above.

Monomers useful herein include substituted or unsubstituted C2 to C40 alpha olefins, preferably, C₂ to C₂₀ alpha olefins, preferably, C₂ to C₁₂ alpha olefins, preferably, ethylene, propylene, butene, pentene, hexene, heptene, octene, nonene, decene, undecene, dodecene and isomers thereof. In a preferred embodiment of the invention, the monomers comprise ethylene and, optional, comonomers comprising one or more C₃ to C₄₀ olefins, preferably, C₄ to C₂₀ olefins, or preferably, C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may, optionally, include heteroatoms and/or one or more functional groups.

Exemplary C₃ to C₄₀ comonomers include propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably, hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives.

In a preferred embodiment one or more dienes are present in the polymer produced herein at up to 10 wt %, preferably, at 0.00001 to 1.0 wt %, preferably, 0.002 to 0.5 wt %, even more preferably, 0.003 to 0.2 wt %, based upon the total weight of the composition. In some embodiments 500 ppm or less of diene is added to the polymerization, preferably, 400 ppm or less, preferably, or 300 ppm or less. In other embodiments, at least 50 ppm of diene is added to the polymerization, or 100 ppm or more, or 150 ppm or more.

Preferred diolefin monomers useful in this invention include any hydrocarbon structure, preferably, C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably, those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacos adiene, heptacosadiene, octacos adiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

In a particularly preferred embodiment the process of the invention relates to the polymerization of ethylene and at least one comonomer having from 3 to 8 carbon atoms, preferably, 4 to 8 carbon atoms. Particularly, the comonomers are propylene, 1-butene, 4-methyl-1-pentene, 3-methyl-1-pentene, 1-hexene and 1-octene, the most preferred being 1-hexene, 1-butene and 1-octene.

Polymerization processes of this invention can be carried out in any manner known in the art. Any suspension, homogeneous, bulk, solution, slurry, or gas phase polymerization process known in the art can be used. Such processes can be run in a batch, semi-batch, or continuous mode. Gas phase polymerization processes and slurry processes are preferred. (A homogeneous polymerization process is defined to be a process where at least 90 wt % of the product is soluble in the reaction media.) A bulk homogeneous process is particularly preferred. (A bulk process is defined to be a process where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorided C₄₋₁₀ alkanes, chlorobenzene, and aromatic and alkylsubstituted aromatic compounds, such as benzene, toluene, mesitylene, and xylene. Suitable solvents also include liquid olefins, which may act as monomers or comonomers, including ethylene, propylene, 1-butene, 1-hexene, 1-pentene, 3-methyl-l-pentene, 4-methyl-l-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably, aromatics are present in the solvent at less than 1 wt %, preferably, less than 0.5 wt %, preferably, less than 0 wt % based upon the weight of the solvents.

### Gas phase polymerization

Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

### Slurry phase polymerization

A slurry polymerization process generally operates between 1 to about 50 atmosphere pressure range (15 psi to 735 psi, 103 kPa to 5068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process must be operated above the reaction diluent critical temperature and pressure. Preferably, a hexane or an isobutane medium is employed.

### Polyolefin Products

This invention also relates to compositions of matter produced by the methods described herein.

In a preferred embodiment, the process described herein produces ethylene homopolymers or ethylene copolymers, such as ethylene-alpha-olefin (preferably C₃ to C20) copolymers (such as ethylene-propylene copolymers, ethylene-butene copolymers, ethylene-hexene, and/or ethylene-octene copolymers).

Likewise, the process of this invention produces ethylene copolymers. In a preferred embodiment, the copolymers produced herein comprise ethylene and from 0 to 25 mol % (alternately from 0.5 to 20 mol %, alternately from 1 to 15 mol %, preferably from 3 to 10 mol %) of one or more C₃ to C₂₀ olefin comonomer (preferably C₃ to C₁₂ alpha-olefin, preferably propylene, butene, hexene, octene, decene, dodecene, preferably propylene, butene, hexene, octene), with the balance being made up of ethylene.

In a preferred embodiment, the monomer is ethylene and the comonomer is hexene, preferably from 1 to 15 mol % hexene, alternately 1 to 10 mol %.

In particular this invention relates to an ethylene polymer composition having: 1) at least 50 mol % ethylene; 2) a density of 0.91 g/cc or more, preferably 0.935 g/cc or more; 3) a melt index (ASTM 1238, 190° C., 2.16kg) of 20 dg/min or less.

Preferably, the polymers produced herein have an Mw of 5,000 to 1,000,000 g/mol (preferably 25,000 to 750,000 g/mol, preferably 50,000 to 500,000 g/mol), and/or an

Mw/Mn of greater than 1 to 40 (alternately 1.2 to 20, alternately 1.3 to 10, alternately 1.4 to 5).

In a preferred embodiment, the polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least three peaks or inflection points. An inflection point is that point where the second derivative of the curve changes in sign (e.g., from negative to positive or vice versus).

Usefully, in a preferred embodiment, the polymer produced herein has a bimodal molecular weight distribution as determined by Gel Permeation Chromatography (GPC). By “bimodal” is meant that the GPC trace has three peaks or inflection points.

Unless otherwise indicated modality, Mw, Mn, Mz, MWD, g value and g′ᵥᵢₛ are determined by using GPC 4D.

### Molecular Weight, Comonomer Composition and Long Chain Branching Determination by Polymer Char GPC-IR Hyphenated with Multiple Detectors (GPC-4D)

Unless otherwise indicated, the distribution and the moments of molecular weight (Mw, Mn, Mw/Mn, etc.), the comonomer content (C₂, C₃, C₆, etc.) and the branching index (g′) are determined by using a high temperature Gel Permeation Chromatography (Polymer Char GPC-IR) equipped with a multiple-channel band-filter based Infrared detector IRS, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and detectors are contained in an oven maintained at 145° C. Given amount of polymer sample is weighed and sealed in a standard vial with 80-μL flow marker

(Heptane) added to it. After loading the vial in the autosampler, polymer is automatically dissolved in the instrument with 8 ml added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IRS broadband signal intensity (1), using the following equation: c=βI, where β is the mass constant determined with PE or PP standards. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} \text{/} K )}{a + 1} + \frac{{a}_{PS} + 1}{a + 1} log {M}_{PS}$$

where the variables with subscript “PS” stand for polystyrene while those without a subscript are for the test samples. In this method, αₚₛ =0.67 and K_{PS} =0.000175 while α and K are for other materials are as calculated as published in literature (Sun, T. et al. Macromolecules, 2001, 34, 6812.), except that for purposes of this invention and the claims thereto, c and K are 0.695 and 0.000579 respectively, for ethylene polymers; α and K are 0.705 and 0.0002288 respectively for propylene polymers; and α and K are 0.695 and 0.000579*(1-0.0075*wt % hexene comonomer), respectively, for ethylene-hexene copolymer.

The comonomer composition is determined by the ratio of the IRS detector intensity corresponding to CH₂ and CH₃ channel calibrated with a series of PE and PP homo/copolymer standards whose nominal value are predetermined by NMR or FTIR.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IRS analysis, A₂ is the second virial coefficient, P(θ) is the form factor for a monodisperse random coil, and Kₒ is the optical constant for the system:

$${K}_{o} = \frac{4 {π}^{2} {{n}^{2} ( dn \text{/} dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For the ethylene-hexene copolymers analyzed, do/dc=0.1048 ml/mg and A₂=0.0015.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IRS broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IRS-LS-VIS method as follows. The average intrinsic viscosity, [η]_{avg}, of the sample is calculated by

$${[ η ]}_{avg} = \frac{Σ {{c}_{i} [ η ]}_{i}}{Σ {c}_{i}}$$

where the summations are over the chromatographic slices, i, between the integration limits. The branching index g′ᵥᵢₛ is defined as

$${g}_{vis}^{′} = \frac{{[ η ]}_{avg}}{{kM}_{v}^{α}} ,$$

where Mᵥ is the viscosity-average molecular weight based on molecular weights determined by LS analysis and the K and α are for the reference linear polymer, which for purposes of this invention and claims thereto, α=0.695 and k=0.000579 for linear ethylene polymers, α=0.705 k=0.000262 for linear propylene polymers, α=0.695 and k=0.000181 for linear butene polymers, and α is 0.695 and K is 0.000579*(1-0.0075*wt % hexene comonomer) for ethylene-hexene copolymer. Concentrations are expressed in g/cm³, molecular weight is expressed in g/mole, and intrinsic viscosity is expressed in dL/g unless otherwise noted.

In a preferred embodiment, the polymer produced herein has a composition distribution breadth index (CDBI) of 50% or more, preferably 60% or more, preferably 70% or more. CDBI is a measure of the composition distribution of monomer within the polymer chains and is measured by the procedure described in PCT publication WO 93/03093, published Feb. 18, 1993, specifically columns 7 and 8 as well as in Wild et al, J. Poly. Sci., Poly. Phys. Ed., Vol. 20, p. 441 (1982) and U.S. Pat. No. 5,008,204, including that fractions having a weight average molecular weight (Mw) below 15,000 are ignored when determining CDBI.

### End Uses

The multi-modal polyolefin produced by the processes disclosed herein and blends thereof are useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

Specifically, any of the foregoing polymers, such as the foregoing ethylene copolymers or blends thereof, may be used in mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents.

Blends

The polymers produced herein may be further blended with additional ethylene polymers (referred to as “second ethylene polymers” or “second ethylene copolymers”) and use in film, molded part and other typical polyethylene applications.

In one aspect of the invention, the second ethylene polymer is selected from ethylene homopolymer, ethylene copolymers, and blends thereof. Useful second ethylene copolymers can comprise one or more comonomers in addition to ethylene and can be a random copolymer, a statistical copolymer, a block copolymer, and/or blends thereof. The method of making the second ethylene polymer is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the second ethylene polymers are made by the catalysts, activators and processes described in

U.S. Pat. No. 6,342,566; 6,384,142; 5,741,563; PCT publications WO 03/040201; and WO 97/19991. Such catalysts are well known in the art, and are described in, for example, ZIEGLER CATALYSTS (Gerhard Fink, Rolf Millhaupt and Hans H. Brintzinger, eds., Springer-Verlag 1995); Resconi et al.; and I, II METALLOCENE-BASED POLYOLEFINS (Wiley & Sons 2000). Additional useful second ethylene polymers and copolymers are described at paragraph [00118] to [00126] at pages 30 to 34 of PCT/US2016/028271, filed Apr. 19, 2016.

This invention further relates to:

1. A process to produce ethylene polymer comprising contacting ethylene, optional comonomer, with a supported catalyst system comprising:

at least one catalyst component comprising a benzindenyl transition metal complex; a support material; and an activator; wherein the benzindenyl transition metal complex is represented by the formula (A):

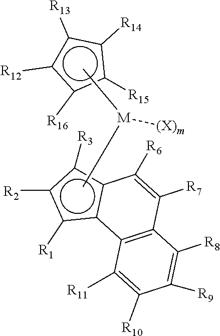

wherein:

R¹ and R³ are hydrogen; each R², R⁶, R⁷, R⁸, R⁹, R¹⁰, R¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or optionally two or more R moieties may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.

2. The process of paragraph 1, wherein M is Hf or Zr.
3. The process of paragraph 1 or 2, wherein the benzindenyl transition metal complex is one or more of: (Benz[e]Ind)₂MX₂, Cp(Benz[e]Ind)MX₂, (MeCp)(Benz[e]Ind)MX₂, (EtCp)(Benz[e]Ind)MX₂, (PrCp)(Benz[e]Ind)MX₂, (1,3-Me₂Cp)(Benz[e]Ind)MX₂, (1,2,4-Me₃Cp)(Benz[e]Ind)MX₂, (Me₄Cp)(Benz[e]Ind)MX₂, (MesCp)(Benz[e]Ind)MX₂, and (PrMe4Cp)(Benz[e]Ind)MX₂, where M is Hf or Zr, and X is I, Cl, Br, Me, Et, Pr, Bu, or phenoxide, preferably Cl.
4. The process of paragraph 1, 2, 3, or 4 wherein at least 1 (alternately at least 2, alternately at least 3, alternately at least 4, alternately 5) of R¹², R¹³, R¹⁴, R¹⁵, and R¹⁶ is a substituted a substituted linear, branched, or cyclic C₁ to C₂₀ hydrocarbyl group (preferably C₁-C₆ hydrocarbyl group, e.g., a methyl, an ethyl, a propyl, a butyl, a cyclohexyl, or a phenyl), where, optionally, two or more R moieties may together form a fused ring or ring system.
5. The process of any of the preceding paragraphs 1 to 4, wherein the support material has a surface area in the range of from 10 to 700 m²/g and an average particle diameter in the range of from 10 to 500 μm.
6. The process of any of the preceding paragraphs 1 to 5, wherein the support material is selected from the group consisting of silica, alumina, silica-alumina, and combinations thereof.
7. The process of any of the preceding paragraphs 1 to 6, wherein the support material is fluoride, preferably the support material has a fluorine concentration in the range of 0.6 to 3.5 wt %, based upon the weight of the support material.
8. The process of any of the preceding paragraphs 1 to 7, wherein the activator comprises alumoxane and or a non coordinating anion.
9. The process of any of the preceding paragraphs 1 to 7, wherein the activator comprises one or more of: methylalumoxane, N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis (3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl) pyrrolidinium; and tetrakis(pentafluorophenyl)borate, and 4-(tris(pentafluorophenyl)borate)-2,3,5,6-tetrafluoropyridine.
10. A process according to any of the above paragraphs 1 to 9, wherein the monomer is selected from the group consisting of ethylene, propylene, 1-butene, 1-hexene, 1-octene and combinations thereof, preferably the monomers consist essentially of: 1) ethylene, and 2) propylene, 1-butene, 1-hexene, 1-octene or combinations thereof
11. A process according to any of the above paragraphs 1 to 10, wherein the monomers are ethylene and one or more of 1-butene, 1-hexene, 1-octene.
12. A process according to any of the above paragraphs 1 to 11, wherein the polymerization is carried out in slurry phase and or in gas phase.
13. A process according to any of above paragraphs 1 to 12 further comprising obtaining a polyolefin having a density of 0.910 or more and a melt index (2.16 kg, 190° C.) of 20 dg/min or less.
14. The process of any of above paragraphs 1 to 13 wherein the process is a continuous process.
15. A supported catalyst system comprising:

at least one catalyst component comprising a benzindenyl transition metal complex; a support material; and an activator; wherein the benzindenyl transition metal complex is represented by the formula (A):

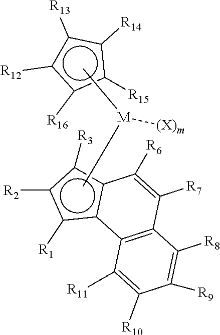

wherein:
R¹ and R³, are hydrogen; each R², R⁶, R⁷, R⁸, R⁹, R¹⁰, R¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or, optionally, two or more R moieties may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.
16. The supported catalyst system of paragraph 15, wherein at least 1 (alternately at least 2, alternately at least 3, alternately at least 4, alternately 5) of R¹², R¹³, R¹⁴, R¹⁵, and R¹⁶ is a substituted a substituted linear, branched, or cyclic C₁ to C₂₀ hydrocarbyl group, where, optionally, two or more R moieties may together form a fused ring or ring system, preferably at least 1 (alternately at least 2, alternately at least 3, alternately at least 4, alternately 5) of R¹², R¹³, R¹⁴, R¹⁵, and R¹⁶ is a substituted linear, branched linear, or cyclic C₁-C₆ hydrocarbyl group (e.g., a methyl, an ethyl, a propyl, a butyl, a cyclohexyl, or a phenyl).
17. The supported catalyst system of paragraph 15 or 16, wherein the activator comprises alumoxane and /or a non coordinating anion.
18. A benzindenyl transition metal complex represented by the formula (A):

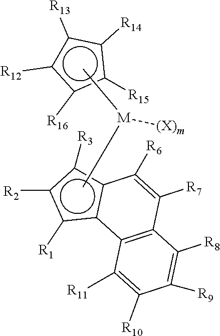

wherein:
R¹ and R³, are hydrogen;
each R², R⁶, R⁷, R⁸, R⁹, R¹⁰, R₁₁, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or, optionally, two or more R moieties may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.
19. The benzindenyl transition metal complex catalyst of paragraph 18, wherein at least 1 (alternately at least 2, alternately at least 3, alternately at least 4, alternately 5) of R¹², R¹³, R¹⁴, R¹⁵, and R¹⁶ is a substituted a substituted linear, branched, or cyclic C₁ to C₂₀ hydrocarbyl group, where, optionally, two or more R moieties may together form a fused ring or ring system, preferably at least 1 (alternately at least 2, alternately at least 3, alternately at least 4, alternately 5) of R¹², R¹³, R¹⁴, R¹⁵, and R¹⁶ is a substituted linear, branched linear, or cyclic C₁-C₆ hydrocarbyl group (e.g., a methyl, an ethyl, a propyl, a butyl, a cyclohexyl, or a phenyl).

### Experimental

All manipulations were done in a nitrogen purged glove box unless stated otherwise. Anhydrous solvents were purchased from Aldrich and purged with nitrogen prior to use. 30 wt % MAO in toluene was purchased from Albemarle. Trioctylaluminum was purchased from Akzo Nobel. Ethylene, isobutane and nitrogen used in the polymerizations were treated with 3A sieves and a supported copper catalyst prior to use to remove water and oxygen. Deuterated solvents were purchased from Cambridge Isotope Laboratories and dried over 3A molecular sieves and purged with nitrogen prior to use. 1H NMR spectra were obtained using a 400 MHz Bruker spectrometer.

Preparation of Lithium (benz[e]indenide).

To a hazy yellow-white solution of benzlelindene (8.80 g, 53.0 mmol, 1.00 eq.) in ether (75 mL) at −35C was added 2.65 M butyllithium in hexanes (20.0 mL, 53.0 mmol, 1.00 eq.) to give a brown solution. The reaction was stirred 30 minutes and then evaporated under vacuum, leaving manila solid. The solid was washed with pentane (2×40 mL) and dried under vacuum. Yield 8.86 g (97%) light manila powder. ¹H NMR (THF-d8): δ 8.04 (dm, 1H), 7.50 (dm, 1H), 7.45 (dm, 1H), 7.10 (tm, 1H), 6.92 (tm, 1H), 6.77 (d, 1H), 6.61 (m, 1H), 6.47 (m, 1H), 6.10 (m, 1H).

Preparation of rac/meso Bis(benz[e]indenyl)zirconium dichloride, (Benz[e]Ind)₂ZrCl₂.

To a dark brown solution of lithium (benz[e]indenide) (1.81 g, 10.5 mmol, 2.00 eq.) in ether (25 mL) was added zirconium tetrachloride bis(etherate) (2.00 g, 5.25 mmol, 1.00 eq.) to give a cloudy orange-brown mixture. The reaction was stirred 21 hours to give a cloudy tan mixture, then evaporated under vacuum to leave tan solid. The solid was extracted with dichloromethane (2×100 mL) and the mixture filtered to give a yellow solution and tan solid. The solution was evaporated under vacuum, leaving manila-yellow solid. The solid was washed with pentane (2×30 mL) and dried under vacuum. Yield 2.34 g (91%) light manila powder. ¹H NMR (CD₂Cl₂): δ 7.99 (dm, 1H), 7.92 (m, 1H), 7.84 (m, 2H), 7.64-7.55 (m, 6H), 7.42-7.39 (m, 2H), 6.70 (m, 1H), 6.53 (m, 1H), 6.46-6.44 (m, 2H), 6.25 (m, 1H).

Preparation of (Benz[e]indenyl)(propyltetramethylcyclopentadienyl)zirconium dichloride, (Benz[e]Ind)(PrMe₄Cp)Cl₂.

To a pale yellow solution of (propyltetramethylcyclopentadienyl)zirconium trichloride hemi(etherate)(2.49 g, 6.26 mmol, 1.00 eq.) in ether (30 mL) was added lithium (benzlelindenide)(1.08 g, 6.33 mmol, 1.00 eq.) to give a cloudy manila-brown mixture that turned manila-yellow after stirring 30 minutes. The reaction was stirred 20 hours to give a cloudy manila mixture, then evaporated under vacuum to leave manila-yellow solid. The solid was extracted with dichloromethane (30 mL, then 3×5 mL) and the mixture filtered to give a yellow-orange solution and gray solid. The solution was evaporated under vacuum, leaving yellow-orange solid. The solid was washed with pentane (20 mL) and dried under vacuum. Yield 2.30 g (75%) pale yellow-manila powder. ¹H NMR (CD₂Cl₂): δ 8.01 (dm, 1H), 7.81 (dm, 1H), 7.60-7.50 (m, 3H), 7.40 (d, 1H), 6.71 (m, 1H), 6.34 (m, 2H), 2.45 (m, 2H), 2.04 (s, 6H), 2.02 (s, 6H), 1.40 (m, 2H), 0.94 (t, 3H).

Preparation of (Benz[e]indenyl)(ethyltetramethylcyclopentadienyl)zirconium dichloride, (Benz[e]Ind)(EtMe₄Cp)Cl₂.

To a light manila suspension of (ethyltetramethylcyclopentadienyl)zirconium trichloride (dimethoxyethane) (2.50 g, 5.72 mmol, 1.00 eq.) in ether (30 mL) was added lithium (benzlelindenide) (0.99 g, 5.75 mmol, 1.00 eq.) to give a cloudy manila mixture. The mixture was stirred 18 hours, then evaporated under vacuum to leave manila solid. The solid was extracted with dichloromethane (30 mL, then 3×5 mL) and the mixture filtered to give an amber solution and white solid. The solution was evaporated under vacuum, leaving manila solid. The solid was washed with pentane (20 mL) and dried under vacuum. Yield 2.59 g (95%) light manila powder. ¹H NMR (CD2Cl₂): δ 8.00 (dm, 1H), 7.81 (dm, 1H), 7.60-7.50 (m, 3H), 7.40 (dd, 1H), 6.71 (m, 1H), 6.34 (M, 2H), 2.49 (q, 2H), 2.05 (s, 6H), 2.02 (s, 6H), 1.00 (t, 3H).

Preparation of (Benz[e]indenyl)(pentamethylcyclopentadienyl)zirconium dichloride, (Benz[e]Ind)(Me5Cp)Cl₂.

To a creamy-white suspension of (pentamethylcyclopentadienyl)zirconium trichloride (dimethoxyethane) (2.50 g, 5.91 mmol, 1.00 eq.) in ether (30 mL) was added lithium (benzlelindenide) (1.02 g, 5.92 mmol, 1.00 eq.) to give a cloudy manila mixture. The mixture was stirred 20 hours, then evaporated under vacuum to leave manila solid. The solid was extracted with dichloromethane (25 mL, then 3×5 mL) and the mixture filtered to give an amber solution and gray-white solid. The solution was evaporated under vacuum, leaving manila solid. The solid was washed with pentane (20 mL) and dried under vacuum. Yield 2.48 g (91%) manila-yellow powder. ¹H NMR (CD₂Cl₂): δ 8.01 (dt, 1H), 7.81 (dm, 1H), 7.60-7.50 (m, 3H), 7.41 (dd, 1H), 6.71 (m, 1H), 6.33 (M, 2H), 2.03 (s, 15H).

Preparation of (Benz[e]indenyl)(tetramethylcyclopentadienyl)zirconium dichloride, (Benz[e]Ind)(Me₄Cp)Cl₂.

To a rose suspension of (tetramethylcyclopentadienyl)zirconium trichloride (dimethoxyethane) (2.49 g, 6.09 mmol, 1.00 eq.) in ether (30 mL) was added lithium (benzlelindenide) (1.05 g, 6.10 mmol, 1.00 eq.) to give a cloudy manila mixture. The reaction was stirred 20 hours to give a cloudy manila-yellow mixture, then evaporated under vacuum to leave manila-yellow solid. The solid was extracted with dichloromethane (30 mL, then 3×5 mL) and the mixture filtered to give an amber solution and gray solid. The solution was evaporated under vacuum, leaving light manila-yellow solid. The solid was washed with pentane (20 mL) and dried under vacuum. Yield 2.37 g (87%) light manila-yellow powder. ¹H NMR (CD₂Cl₂): δ 8.08 (dt, 1H), 7.83, (dm, 1H), 7.62 (td, 1H), 7.56-7.52 (m, 2H), 7.48 (dd, 1H), 6.89 (m, 1H), 6.67 (t, 1H), 6.50 (m, 1H), 5.89 (s, 1H), 1.91 (s, 3H), 1.91 (s,3H), 1.90 (s, 3H), 1.78 (s, 3H). Preparation of (Benz[e]indenyl)(1,2,4-trimethylcyclopentadienyl)zirconium dichloride, (Benz[e]Ind)(1,2,4-Me₃Cp)ZrCl₂.

To a creamy-white suspension of (1,2,4-trimethylcyclopentadienylzirconium trichloride (dimethoxyethane) (2.50 g, 6.33 mmol, 1.00 eq.) in ether (30 mL) was added lithium (benzlelindenide) (1.09 g, 6.33 mmol, 1.00 eq.) to give a cloudy manila mixture. The reaction was stirred 22 hours and then evaporated under vacuum to leave manila solid. The solid was extracted with dichloromethane (30 mL, then 3×5 mL) and the mixture filtered to give an amber-yellow solution and light brown solid. The solution was evaporated under vacuum, leaving manila solid. The solid was washed with pentane (2×20 mL) and dried under vacuum. Yield 2.67 g (97%) manila powder. ¹H NMR (CD₂Cl₂): δ 8.09 (dm, 1H), 7.83 (dm, 1H), 7.63 (tm, 1H), 7.58-7.53 (m, 2H), 7.48 (dm, 1H), 6.91 (m, 1H), 6.70 (t, 1H), 6.52 (m, 1H), 5.98 (s, 2H), 2.05 (s, 3H), 1.94 (s,3H), 1.88 (s, 3H).

Preparation of (Benz[e]indenyl)(1,3-dimethylcyclopentadienyl)zirconium dichloride, (Benz[e]Ind)(1,3-Me₂Cp)ZrCl₂.

To a creamy-white suspension of (1,3-dimethylcyclopentadienylzirconium trichloride (dimethoxyethane) (2.50 g, 6.56 mmol, 1.00 eq.) in ether (30 mL) was added lithium (benzlelindenide) (1.13 g, 6.56 mmol, 1.00 eq.) to give a cloudy manila mixture. The reaction was stirred 17 hours and then evaporated under vacuum to leave manila solid. The solid was extracted with dichloromethane (30 mL, then 3×5 mL) and the mixture filtered to give an amber-orange solution and tan-gray solid. The solution was evaporated under vacuum, leaving manila solid. The solid was washed with pentane (2×15 mL) and dried under vacuum. Yield 2.66 g (96%) manila powder. 41 NMR (CD2Cl₂): δ 8.13 (dm, 1H), 7.85 (dm, 1H), 7.65 (tm, 1H), 7.59-7.55 (m, 2H), 7.50 (dd, 1H), 6.97 (m, 1H), 6.83 (t, 1H), 6.60 (m, 1H), 5.94 (t, 1H), 5.71 (t, 1H), 5.32 (m, 1H), 2.03 (s, 6H).

Preparation of (Benz[e]indenyl)(methylcyclopentadienyl)zirconium dichloride, (Benz[e]Ind)(MeCp)ZrCl₂.

To a pale peach-white suspension of (methylcyclopentadienyl)zirconium trichloride (dimethoxyethane) (2.49 g, 6.79 mmol, 1.00 eq.) in ether (30 mL) was added lithium (benzlelindenide) (1.17 g, 6.80 mmol, 1.00 eq.) to give a cloudy orange-brown mixture that turned light brown after stirring 15 minutes. The reaction was stirred 20 hours and then evaporated under vacuum to leave manila solid. The solid was extracted with dichloromethane (30 mL, then 3×5 mL) and the mixture filtered to give an amber orange solution and manila solid. The solution was evaporated under vacuum, leaving manila solid. The solid was washed with pentane (2×20 mL) and dried under vacuum. Yield 2.68 g (97%) manila powder. 41 NMR (CD₂Cl₂): δ 8.15 (d, 1H), 7.86 (d, 1H), 7.67 (td, 1H), 7.61-7.56 (m, 2H), 7.52 (d, 1H), 6.99 (m, 1H), 6.92 (t, 1H), 6.65 (m, 1H), 5.98 (q, 1H), 5.92 (q, 1H), 5.87 (q, 1H), 5.82 (q, 1H), 2.09 (s, 3H).

Preparation of (Benz[e]indenyl)cyclopentadienylzirconium dichloride, (Benz[e]Ind)CpZrCl₂.

To a pale gray-white suspension of cyclopentadienylzirconium trichloride (dimethoxyethane) (2.50 g, 7.09 mmol, 1.00 eq.) in ether (30 mL) was added lithium (benzlelindenide) (1.22 g, 7.09 mmol, 1.00 eq.) to give a cloudy burnt-orange mixture that turned light brown after stirring 30 minutes. The reaction was stirred 20 hours and then evaporated under vacuum to leave manila solid. The solid was extracted with dichloromethane (50 mL, then 3×5 mL) and the mixture filtered to give an amber orange solution and beige-gray solid. The solution was evaporated under vacuum, leaving manila solid. The solid was washed with pentane (2×20 mL) and dried under vacuum. Yield 2.72 g (99%) manila powder. 41 NMR (CD₂Cl₂): δ 8.16 (dd, 1H), 7.87 (d, 1H), 7.68 (td, 1H), 7.62-7.57 (m, 2H), 7.53 (d, 1H), 7.01 (m, 1H), 6.93 (t, 1H), 6.66 (m, 2H), 6.17 (s, 5H).

Preparation of (Benz[e]indenyl)(ethylcyclopentadienyl)zirconium dichloride, (Benz[e]Ind)(EtCp)ZrCl₂.

To a creamy-white suspension of (ethylcyclopentadienyl)zirconium trichloride (dimethoxyethane) (2.50 g, 6.56 mmol, 1.00 eq.) in ether (30 mL) was added lithium (benzlelindenide) (1.13 g, 6.56 mmol, 1.00 eq.) to give a cloudy burnt-orange mixture that turned manila after stirring 5 minutes. The reaction was stirred 17 hours and then evaporated under vacuum to leave manila solid. The solid was extracted with dichloromethane (30 mL, then 3×5 mL) and the mixture filtered to give an amber orange solution and manila solid. The solution was evaporated under vacuum, leaving manila-yellow solid. The solid was washed with pentane (2×20 mL) and dried under vacuum. Yield 2.68 g (97%) manila powder. ¹H NMR (CD₂Cl₂): δ 8.15 (d, 1H), 7.86 (d, 1H), 7.67 (dm, 1H), 7.61-7.56 (m, 2H), 7.53 (d, 1H), 7.00 (m, 1H), 6.92 (t, 1H), 6.64 (m, 1H), 5.99 (q, 1H), 5.93 (q, 1H), 5.88 (m, 2H), 2.51 (q, 2H), 1.04 (t, 3H).

Preparation of (Benz[e]indenyl)(propylcyclopentadienyl)zirconium dichloride, (Benz[e]Ind)(PrCp)Cl₂.

To a gray-white suspension of (propylcyclopentadienyl)zirconium trichloride (dimethoxyethane) (2.50 g, 6.33 mmol, 1.00 eq.) in ether (30 mL) was added lithium (benzlelindenide) (1.09 g, 6.33 mmol, 1.00 eq.) to give a cloudy manila mixture. The reaction was stirred 16 hours to give a cloudy manila-yellow mixture, then evaporated under vacuum to leave manila-yellow solid. The solid was extracted with dichloromethane (30 mL, then 3×5 mL) and the mixture filtered to give an amber solution and gray solid. The solution was evaporated under vacuum, leaving light manila-yellow solid. The solid was washed with pentane (20 mL) and dried under vacuum. Yield 2.37 g (87%) light manila-yellow powder. ¹H NMR (CD2Cl₂): δ 8.15 (dt, 1H), 7.86 (d, 1H), 7.67 (tm, 1H), 7.61-7.56 (m, 2H), 7.52 (d, 1H), 6.99 (m, 1H), 6.92 (t, 1H), 6.64 (m, 1H), 6.00 (q, 1H), 5.94-5.90 (m, 2H), 5.86 (q, 1H), 2.42 (m, 2H), 1.43 (m, 2H), 0.85 (t, 3H).

Preparation of (Benz[e]indenyl)(isopropylcyclopentadienyl)zirconium dichloride, (Benz[e]Ind)(PrⁱCp)Cl₂.

To an off-white suspension of (isopropylcyclopentadienyl)zirconium trichloride (dimethoxyethane) (2.50 g, 6.33 mmol, 1.00 eq.) in ether (45 mL) was added lithium (benzlelindenide) (1.09 g, 6.33 mmol, 1.00 eq.) to give a cloudy orange mixture that slowly became thick with manila precipitate. The reaction was stirred 21 hours to give a cloudy manila mixture, then evaporated under vacuum to leave manila solid. The solid was extracted with dichloromethane (30 mL, then 3×5 mL) and the mixture filtered to give a light yellow solution and off-white solid. The solution was evaporated under vacuum, leaving manila solid. The solid was washed with pentane (30 mL) and dried under vacuum. Yield 2.64 g (96%) light yellow powder. 41 NMR (CD2Cl₂): δ 8.15 (dd, 1H), 7.86 (d, 1H), 7.67 (td, 1H), 7.60-7.52 (m, 3H), 7.00 (m, 1H), 6.93 (t, 1H), 6.63 (m, 1H), 5.98 (m, 1H), 5.93-5.89 (m, 3H), 2.94 (m, 1H), 1.05 (m, 6H).

Preparation of (Benz[e]indenyl)(cyclopentylcyclopentadienyl)zirconium dichloride, (Benz[e]Ind)(CyclopentylCp)Cl₂.

To a manila suspension of (cyclopentylcyclopentadienyl)zirconium trichloride (dimethoxyethane) (2.49 g, 5.92 mmol, 1.00 eq.) in ether (30 mL) was added lithium (benz[e]indenide) (1.02 g, 5.92 mmol, 1.00 eq.) to give a cloudy orange mixture that soon turned manila. The reaction was stirred 21 hours to give a cloudy light manila mixture, then evaporated under vacuum to leave light manila solid. The solid was extracted with dichloromethane (70 mL, then 3×5 mL) and the mixture filtered to give a pale yellow sol and light manila solid. The solution was evaporated under vacuum, leaving light manila solid. The solid was washed with pentane (20 mL) and dried under vacuum. Yield 2.58 g (95%) pale yellow powder. 41 NMR (CD2Cl₂): δ 8.15 (dm, 1H), 7.86 (dm, 1H), 7.67 (tm, 1H), 7.61-7.56 (m, 2H), 7.53 (dm, 1H), 7.00 (m, 1H), 6.93 (t, 1H), 6.63 (m, 1H), 6.01 (qm, 1H), 5.94-5.87 (m, 3H), 3.00 (m, 1H), 1.87 (m, 2H), 1.60 (m, 4H), 1.32 (m, 2H).

Preparation of (Benz[e]indenyl)(1-butyl-3-methylcyclopentadienyl)zirconium dichloride, (Benz[e]Ind)(1-Bu-3-MeCp)Cl₂.

To a manila suspension of (1-butyl-3-methylcyclopentadienyl)zirconium trichloride (dimethoxyethane) (2.50 g, 5.91 mmol, 1.00 eq.) in ether (30 mL) was added lithium (benz[e]lindenide) (1.02 g, 5.92 mmol, 1.00 eq.) to give a manila mixture. The reaction was stirred 18 hours to give a cloudy light-yellow mixture, then evaporated under vacuum to leave light yellow-white solid. The solid was extracted with dichloromethane (30 mL, then 3×5 mL) and the mixture filtered to give a pale yellow solution and off-white solid. The solution was evaporated under vacuum, leaving yellow solid. The solid was washed with pentane (20 mL) and dried under vacuum. Yield 2.67 g (98%) light yellow powder. 41 NMR (CD2Cl₂): δ 8.09 (dt, 1H), 7.83 (d, 1H), 7.63 (tm, 1H), 7.58-7.53 (m, 2H), 7.48 (dd, 1H), 6.91 (m, 1H), 6.70 (t, 1H), 6.52 (m, 1H), 6.00 (m, 2H), 2.94 (m, 1H), 1.05 (m, 6H).

Preparation of (Benz[e]indenyl)(1,2-dimethyl-4-propylcyclopentadienyOzirconium dichloride, (Benz[e]Ind)(1,2-Me₂-4-PrCp)Cl₂.

To a light manila-white suspension of (1,2-dimethyl-4-propylcyclopentadienyl)zirconium trichloride (dimethoxyethane) (2.50 g, 5.91 mmol, 1.00 eq.) in ether (60 mL) was added lithium (benz[e]indenide) (1.02 g, 5.92 mmol, 1.00 eq.) to give a manila mixture thick with precipitate. The reaction was stirred 18 hours to give a cloudy light-yellow mixture, then evaporated under vacuum to leave light yellow-white solid. The solid was extracted with dichloromethane (30 mL, then 3×5 mL) and the mixture filtered to give a pale yellow solution and off-white solid. The solution was evaporated under vacuum, leaving yellow solid. The solid was washed with pentane (20 mL) and dried under vacuum. Yield 2.67 g (98%) light yellow powder. 41 NMR (CD2Cl₂): δ 8.09 (dt, 1H), 7.83 (d, 1H), 7.63 (tm, 1H), 7.58-7.53 (m, 2H), 7.48 (dd, 1H), 6.91 (m, 1H), 6.70 (t, 1H), 6.52 (m, 1H), 6.00 (m, 2H), 2.94 (m, 1H), 1.05 (m, 6H).

Preparation of supported Bis(benz[e]indenyl)zirconium dichloride.

30 wt % MAO in toluene (6.24 g, 32.4 mmol, 120 eq.) and 6.50 g toluene were combined to give a colorless solution. The solution was stirred 15 minutes, then bis(benzlelindenyl)zirconium dichloride (0.1324 g, 0.2 mmol, 1.00 eq.) was added to give a yellow-orange solution. The reaction was stirred 15 minutes, then Davison™ 948 silica (5.00g, dried at 600C) was added to give a warm, yellow mixture. The mixture was stirred 10 minutes with a spatula, then dried 23 hours under vacuum. Yield 6.76 g (99%) manila solid. All catalyst compounds were supported in a like manner

### Slurry Polymerizations

All polymerizations were carried out in a 1 L Autoclave Engineers Zipperclave jacketed reactor equipped with a stirrer and baffle, and connected to supplies of ethylene, isobutane, and nitrogen. 30 mL 1-hexene and 50 μL trioctylaluminum were injected into the reactor from a transfer cylinder, and 400 mL isobutane was then added to the reactor. The reactor was heated to 85° C. and the solution was saturated with ethylene at 110psi over the reactor pressure at 85° C. 25 mg supported catalyst was injected into the reactor as a slurry in 2 mL pentane using ethylene at 130psi over the reactor pressure at 85° C. The polymerization was run 40 minutes at 85° C., feeding ethylene on demand at 130 psi over the reactor pressure at 85° C. The reactor was then cooled and vented. The polyethylene was collected and dried at 60° C. overnight in a vacuum oven.

Melt Index (MI, also referred to as 12) is measured according to ASTM D1238 at 190° C., under a load of 2.16 kg unless otherwise noted. The units for MI are g/10 min or dg/min.

High Load Melt Index (HLMI, also referred to as 121) is the melt flow rate measured according to ASTM D-1238 at 190° C., under a load of 21.6 kg. The units for HLMI are g/10 min or dg/min.

Melt Index Ratio (MIR) is the ratio of the high load melt index to the melt index, or 121/12.

| | Activity | | | |
|---|---|---|---|---|
| | (kg/mole | wt % | MI | |
| Catalyst | hr atm) | 1-Hexene | (dg/min) | MIR |
| (1-Bu-3-MeCp)₂ZrCl₂ | 6,637 | 7.12 | 0.11 | 26 |
| CpIndZrCl₂ | 6893 | 6.62 | 0.44 | 19.60 |
| (Benz[e]Ind)₂ZrCl₂ | 7981 | 6.74 | 0.07 | 88.36 |
| Cp(Benz[e]Ind)ZrCl₂ | 4395 | 6.20 | 0.04 | 111.13 |
| (MeCp)(Benz[e]Ind)ZrCl₂ | 4000 | 5.56 | 0.05 | 81.60 |
| (EtCp)(Benz[e]Ind)ZrCl₂ | 6677 | 5.98 | 0.03 | 93.36 |
| (PrCp)(Benz[e]Ind)ZrCl₂ | 8159 | 6.80 | 1.46 | 18.47 |
| (1,3-Me2Cp)(Benz[e]Ind)ZrCl₂ | 9335 | 6.06 | Too low | ND |
| | | | to measure | |
| (1,2,4-Me3Cp)(Benz[e]Ind)ZrCl₂ | 10778 | 6.56 | Too low | ND |
| | | | to measure | |
| (Me4Cp)(Benz[e]Ind)ZrCl₂ | 9407 | 6.22 | 0.03 | 110.78 |
| (Me5Cp)(Benz[e]Ind)ZrCl₂ | 10980 | 6.86 | 0.03 | 93.55 |
| (PrMe4Cp)(Benz[e]Ind)ZrCl₂ | 10747 | 6.60 | 0.08 | 46.54 |

Average of three polymerizations

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, e.g., the terms “comprising,” “consisting essentially of,” “consisting of” also include the product of the combinations of elements listed after the term.

1. A process to produce ethylene polymer comprising contacting ethylene, optional comonomer, with a supported catalyst system comprising:
at least one catalyst component comprising a benzindenyl transition metal complex; a support material; and an activator; wherein the benzindenyl transition metal complex is represented by the formula (A): 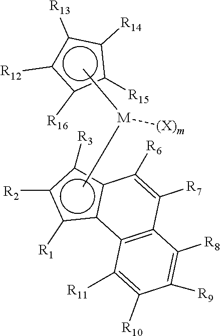
wherein:
R¹ and R³ are hydrogen;
each R², R⁶, R⁷, R⁸, R⁹, R¹⁰, R¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or optionally two or more R moieties may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.

2. The process of claim 1, wherein M is Hf or Zr.

3. The process of claim 1, wherein the benzindenyl transition metal complex is one or more of: (Benz[e]Ind)₂MX₂, Cp(Benz[e]Ind)MX₂, (MeCp)(Benz[e]Ind)MX₂, (EtCp)(Benz[e]Ind)MX₂, (PrCp)(Benz[e]Ind)MX₂, (1,3 -Me₂Cp)(Benz[e]Ind)MX₂, (1,2,4-Me₃Cp)(Benz[e]Ind)MX₂, (Me₄Cp)(Benz[e]Ind)MX₂, (MesCp)(Benz[e]Ind)MX₂, and (PrMe₄Cp)(Benz[e]Ind)MX₂, where M is Hf or Zr, and X is I, Cl, Br, Me, Et, Pr, Bu, or phenoxide.

4. The process of claim 1, wherein the benzindenyl transition metal complex is one or more of: (Benz[e]Ind)₂ZrCl₂, Cp(Benz[e]Ind)ZrCl₂, (MeCp)(Benz[e]Ind)ZrCl₂, (EtCp)(Benz[e]Ind)ZrCl₂, (PrCp)(Benz[e]Ind)ZrCl₂, (1,3 -Me₂Cp) (Benz[e]Ind)ZrCl₂, (1,2,4-Me3Cp)(Benz[e]Ind)ZrCl₂, (Me₄Cp)(Benz[e]Ind)ZrCl₂, (MesCp)(Benz[e]Ind)ZrCl₂, and (PrMe₄Cp)(Benz[e]Ind)ZrCl₂.

5. The process of claim 1, wherein at least 1 (alternately at least 2, alternately at least 3, alternately at least 4, alternately 5) of R¹², R¹³, R¹⁴, R¹⁵, and R¹⁶ is a substituted a substituted linear, branched, or cyclic C₁ to C₂₀ hydrocarbyl group, where, optionally, two or more R moieties may together form a fused ring or ring system.

6. The process of claim 1, wherein at least 1 (alternately at least 2, alternately at least 3, alternately at least 4, alternately 5) of R¹², R¹³, R¹⁴, R¹⁵, and R¹⁶ is a substituted linear, branched linear, or cyclic C₁-C₆ hydrocarbyl group (e.g., a methyl, an ethyl, a propyl, a butyl, a cyclohexyl, or a phenyl).

7. The process of claim 1, wherein the support material has a surface area in the range of from 10 to 700 m²/g and an average particle diameter in the range of from 10 to 500 μm.

8. The process of claim 1, wherein the support material is selected from the group consisting of silica, alumina, silica-alumina, and combinations thereof.

9. The process of claim 1, wherein the support material is fluorided.

10. The process of claim 9, wherein the support material has a fluorine concentration in the range of 0.6 to 3.5 wt %, based upon the weight of the support material.

11. The process of claim 1, wherein the activator comprises alumoxane.

12. The process of claim 1, wherein the activator comprises a non coordinating anion.

13. The process of claim 1, wherein the activator comprises one or more of:
methylalumoxane, N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis (3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis (3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl) pyrrolidinium; and tetrakis(pentafluorophenyl)borate, and 4-(tris(pentafluorophenyl)borate)-2,3,5,6-tetrafluoropyridine.

14. The process of claim 1, wherein the monomers consist essentially of: 1) ethylene, and 2) propylene, 1-butene, 1-hexene, 1-octene or combinations thereof.

15. The process of claim 1, wherein the monomer is selected from the group consisting of ethylene, propylene, 1-butene, 1-hexene, 1-octene and combinations thereof.

16. The process of claim 1, wherein the monomers are ethylene and one or more of 1-butene, 1-hexene, 1-octene.

17. The process of claim 1, wherein the polymerization is carried out in slurry phase.

18. The process of claim 1, wherein the polymerization is carried out in gas phase.

19. The process of claim 1, further comprising obtaining a polyolefin having a density of 0.910 or more and a melt index (2.16 kg, 190° C.) of 2.0 dg/min or less.

20. The process of claim 1, wherein the process is a continuous process.

21. A supported catalyst system comprising:
at least one catalyst component comprising a benzindenyl transition metal complex; a support material; and an activator; wherein the benzindenyl transition metal complex is represented by the formula (A): 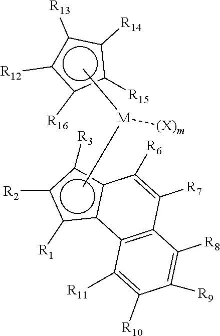
wherein:
R¹ and R³, are hydrogen;
each R², R⁶, R⁷, R⁸, R⁹, R¹⁰, R¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or, optionally, two or more R moieties may together form a fused ring or ring system;
m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.

22. The supported catalyst system of claim 21, wherein at least 1 (alternately at least 2, alternately at least 3, alternately at least 4, alternately 5) of R¹², R¹³, R¹⁴, R¹⁵, and R¹⁶ is a substituted a substituted linear, branched, or cyclic C₁ to C₂₀ hydrocarbyl group, where, optionally, two or more R moieties may together form a fused ring or ring system.

23. The supported catalyst system of claim 21, wherein at least 1 (alternately at least 2, alternately at least 3, alternately at least 4, alternately 5) of R¹², R¹³, R¹⁴, R¹⁵, and R¹⁶ is a substituted linear, branched linear, or cyclic C₁-C₆ hydrocarbyl group (e.g., a methyl, an ethyl, a propyl, a butyl, a cyclohexyl, or a phenyl).

24. The supported catalyst system of claim 21, wherein the activator comprises alumoxane and /or a non coordinating anion.

25. A benzindenyl transition metal complex represented by the formula (A): 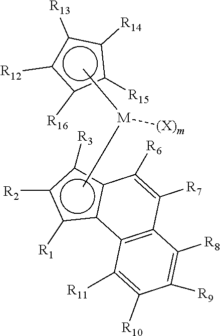
wherein:
R¹ and R³, are hydrogen;
each R², R⁶, R⁷, R⁸, R⁹, R¹⁰, R¹¹, R¹², R¹³, R¹⁴, R¹⁵, and R¹⁶ are each, independently, a hydrogen, or a substituted or unsubstituted linear, branched, or cyclic C₁ to C₂₀ hydrocarbyl group, or, optionally, two or more R moieties may together form a fused ring or ring system; m is 1, 2 or 3; M is a group 4 transition metal; and each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system.
